(19) United States
(12) Patent Application Publication
(10) Pub. No.: US 2002/0093177 A1
(43) Pub. Date: Jul. 18, 2002

(54) STROLLER CAPABLE OF CARRYING A BABY BASKET

(76) Inventor: Chin-Chiao Chen, Taichung Hsien (TW)

Correspondence Address: FOLEY & LARDNER, Suite 500, 3000 K Street N.W., Washington, DC, 20007-5109, US

(21) Appl. No.: 09/760,725

(22) Filed: Jan. 17, 2001

(51) Int. Cl. B62B 7/00

(52) U.S. Cl. 280/647; 280/642

(57) ABSTRACT

A stroller includes a folding mechanism and a basket support frame. The folding mechanism has front and rear folding parts interconnected pivotally for moving toward or away from each other to a folded position or an unfolded position. The front folding parts are connected to a front frame. The rear folding parts are connected to rear and handle frames. The basket support frame includes a substantially U-shaped front support which has two opposite rearwardly extending front arms and an intermediate part between the front arms, a pair of connector tubes, a pair of front rods which have front ends connected pivotally to the intermediate part, and rear ends respectively and telescopically connected to the connector tubes, a pair of rear rods which have front ends respectively connected to the connector tubes, a rear support extending across and connected to rear ends of the rear rods, a pair of front mounting members respectively connecting distal ends of the front arms to the front frame below the front rods, and a pair of rear mounting members disposed on two opposite ends of the rear support and mounted on the rear frame.

### BACKGROUND OF THE INVENTION

1. Field of the Invention

The invention relates to a stroller, more particularly to a foldable stroller provided with a removable basket support frame adapted for supporting a baby basket.

2. Description of the Related Art

A conventional three-wheeled stroller 1 is shown in FIG. 1. As illustrated, the stroller 1 includes a front frame 101, a handle 102 disposed on an upper end of the front frame 101, a rear wheel frame 103 pivotally coupled to a rear end of the front frame 101, and a linkage 104 disposed between and interconnecting the front frame 101 and the rear wheel frame 103. The front frame 101 has a front end provided with a front wheel 105. The rear wheel frame 103 has a lower end provided with two rear wheels 106. The stroller 1 further includes a seat 107 and a canopy 108. The stroller 1 is foldable via a folding mechanism 109 disposed at an intermediate section of the front frame 101. Referring to FIG. 2, when it is desired to fold the stroller 1, an actuating bar 110 mounted on the handle 102 is operated to cause retaining hooks 111 mounted inside the folding mechanism 109 to disengage from retaining pins 112, thereby allowing rearward folding of a rear section of the front frame 101 and the handle 102. With the cooperative movement of the linkage 104, the stroller 1 can be quickly folded. Although the stroller 1 is foldable, it is mainly suited for use by young children that can sit upright. For babies that still cannot sit upright, the stroller 1 is not suitable. There is a need for a stroller that can be adapted for carrying babies as well as young children.

### SUMMARY OF THE INVENTION

Therefore, the main object of the present invention is to provide a stroller capable of carrying a baby basket.

Accordingly, a stroller of this invention includes a wheeled front frame, a wheeled rear frame, a handle frame, a pair of links pivotally interconnecting the front and rear frames, a folding mechanism, and a basket support frame. The folding mechanism has front and rear folding parts interconnected pivotally for moving toward or away from each other to a folded position or an unfolded position. The front folding parts are connected to the front frame. The rear folding parts are connected to the rear and handle frames. The basket support frame includes a substantially U-shaped front support, a pair of connector tubes, a pair of front rods, a pair of rear rods, a rear support, a pair of front mounting members, and a pair of rear mounting members. The front support has two opposite rearwardly extending front arms and an intermediate part between the front arms. The front rods have front ends connected pivotally to the intermediate part, and rear ends respectively and telescopically connected to the connector tubes. The rear rods have front ends respectively connected to the connector tubes, and rear ends extending rearwardly. The rear support extends across and is connected to the rear ends of the rear rods. The front mounting members respectively connect distal ends of the front arms to the front frame below the front rods. The rear mounting members are disposed on two opposite ends of the rear support and are mounted on the rear frame.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional stroller in an unfolded state;

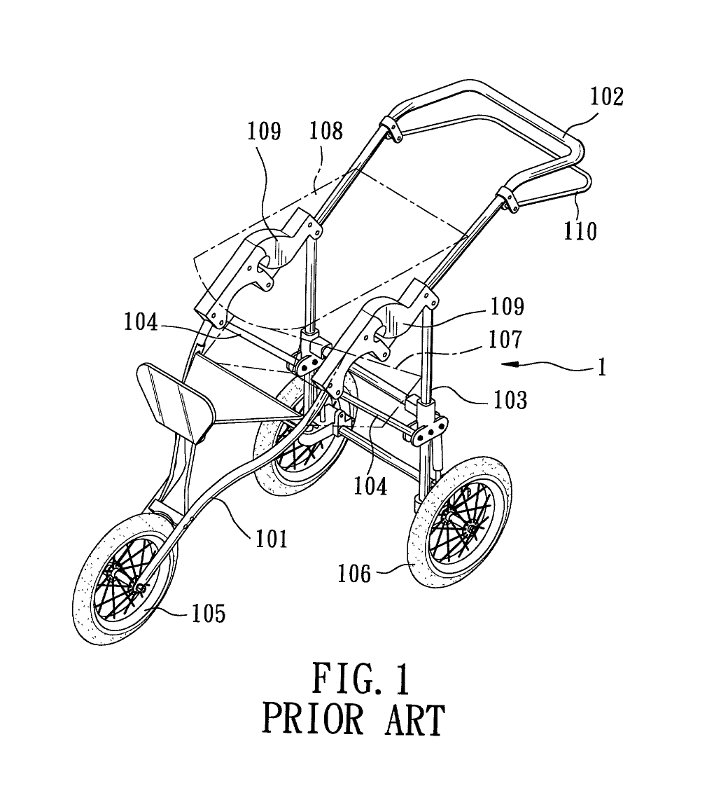

FIG. 2 is a schematic view of the conventional stroller in a folded state;

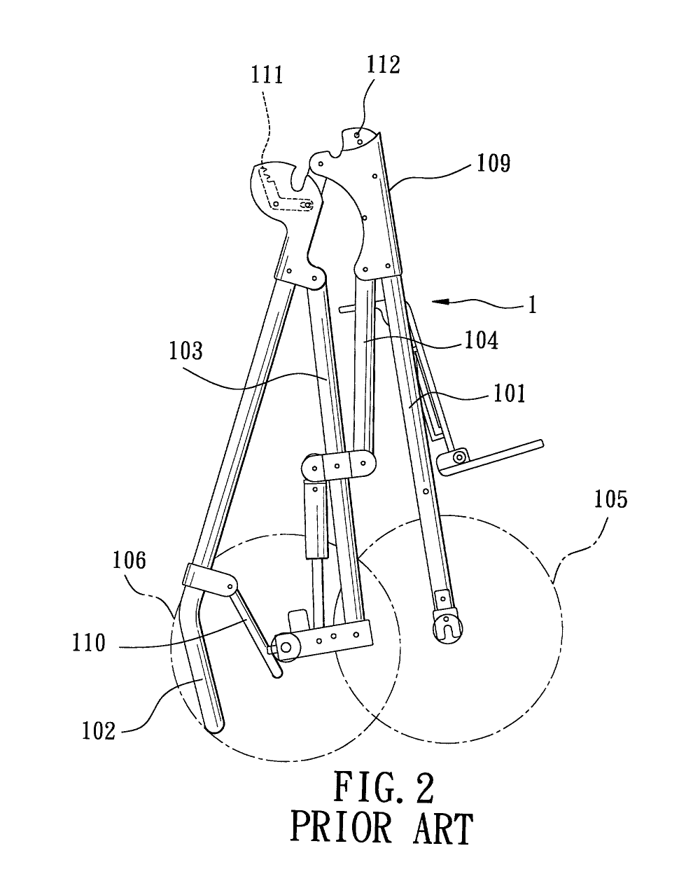

FIG. 3 is a perspective view of the preferred embodiment of a stroller according to the invention in an unfolded state;

FIG. 4 is a partly exploded perspective view of a basket support frame of the preferred embodiment;

FIG. 5 is a fragmentary sectional view illustrating the relationship between a front arm and a front mounting member of the preferred embodiment;

FIG. 6 is a fragmentary sectional view showing the front arm and the front mounting member of FIG. 5 in a folded state;

FIG. 7 is a fragmentary sectional view illustrating a rear mounting member of the preferred embodiment;

FIG. 8 is a side schematic view of the basket support frame of the preferred embodiment in an unfolded state;

FIG. 9 is the same view as FIG. 8 but in a folded state;

FIG. 10 is a schematic view illustrating the preferred embodiment in a folded state; and

FIG. 11 is a perspective view illustrating the preferred embodiment with the basket support frame removed.

### DETAILED DESCRIPTION OF THE PREFERRED EMBODIMENT

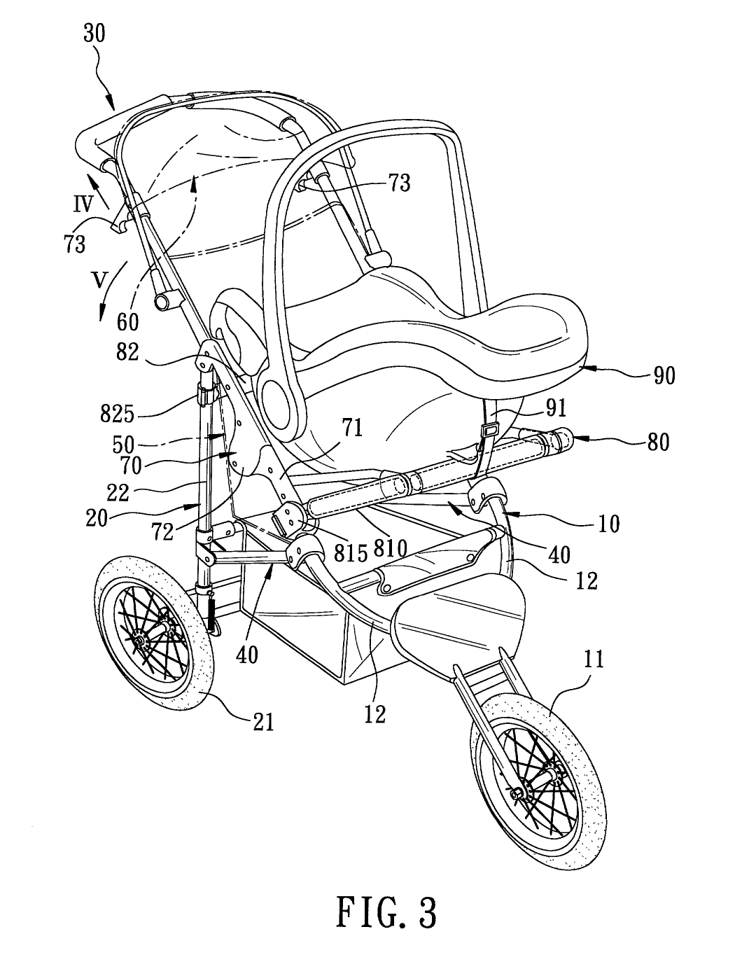

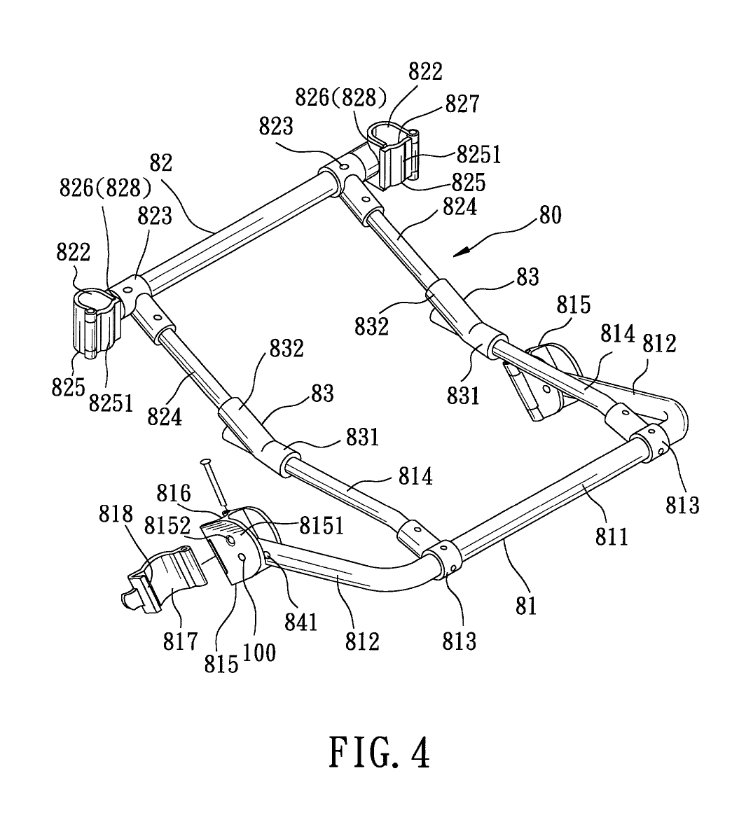

Referring to FIGS. 3 and 4, the preferred embodiment of a stroller according to the present invention is shown to include a wheeled front frame 10, a wheeled rear frame 20, a handle frame 30, a pair of links 40 pivotally interconnecting the front and rear frames 10, 20, a seat 50, a canopy 60, a folding mechanism 70, and a basket support frame 80.

The front frame 10 includes two front legs 12 which extend forwardly, and a front wheel 11 attached to the front legs 12. The rear frame 20 includes two wheeled rear legs 22 that carry a pair of rear wheels 21.

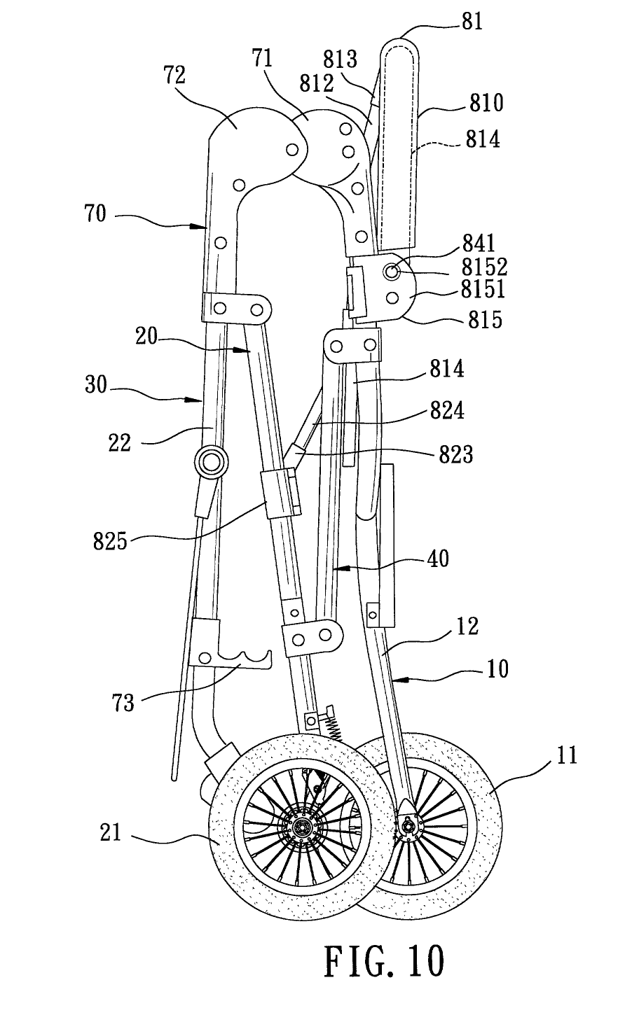

Referring to FIGS. 3 and 10, the folding mechanism 70 has front and rear folding parts 71, 72 which are interconnected pivotally for moving toward or away from each other to a folded position or an unfolded position. The front folding parts 71 are connected to the front frame 10. The rear folding parts 72 are connected to the rear frame 20 and the handle frame 30.

With reference to FIGS. 3 to 9, the basket support frame 80 is adapted for supporting a baby basket 90, and includes a front support 81, a pair of hollow connector tubes 83, a pair of front rods 814, a pair of rear rods 824, a rear support 82, a pair of front mounting members 815, and a pair of rear mounting members 825. The front support 81 is substantially U-shaped and has two opposite rearwardly extending front arms 812 and an intermediate part 811 between the front arms 812. The intermediate part 811 may be fitted with a soft protective covering 810 for cushioning purposes. The front rods 814 have front ends connected pivotally to the intermediate part 811, and rear ends respectively and telescopically connected to the connector tubes 83. The rear rods 824 have front ends connected to the connector tubes 83, and rear ends extending rearwardly. The rear support 82 extends across and is connected to the rear ends of the rear rods 824. In addition, the rear support 82 and the intermediate part 811 are substantially horizontal and parallel to each other.

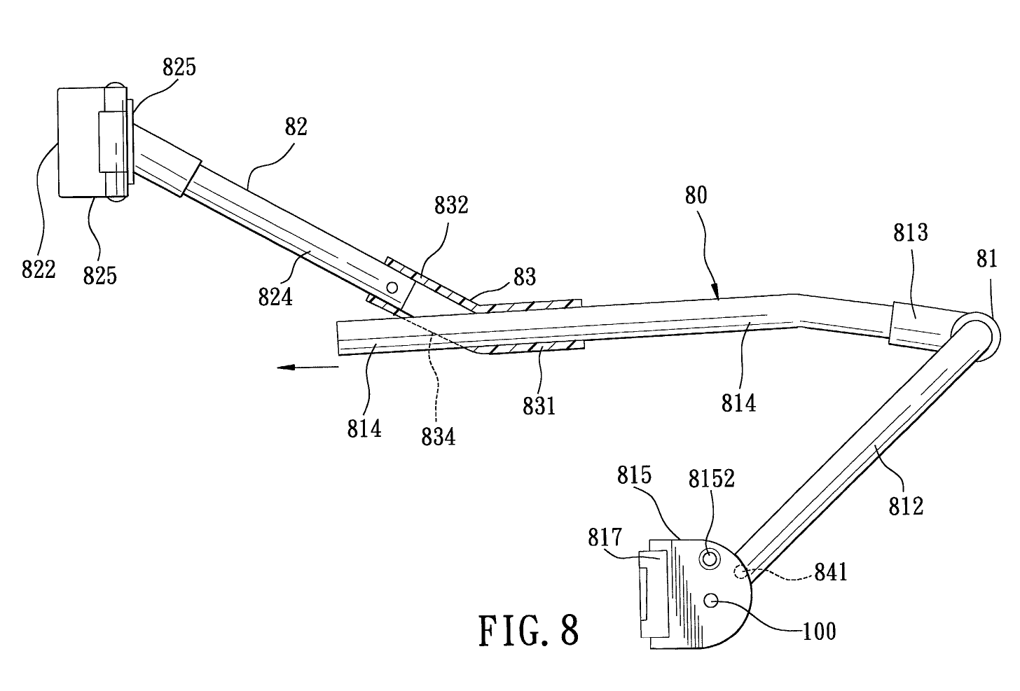

Each of the connector tubes 83 includes a front connecting part 831 connected to a corresponding one of the front rods 814, and a rear connecting part 832 connected to a corresponding one of the rear rods 824. The front connecting part 831 is substantially horizontal in the unfolded position of the folding mechanism 70. The rear connecting part 832 is inclined upward and rearward from the front connecting part 831, and has a passage 834 (see FIG. 8) adjacent to the front connecting part 831. The rear end of the corresponding one of the front rods 814 is received telescopically in the front connecting part 831, and extends outward through the passage 834 (see FIG. 8). The rear rods 824 are respectively and fixedly connected to the rear connecting parts 832 of the connector tubes 83.

The front mounting members 815 respectively and pivotally connect distal ends of the front arms 812 of the front support 81 to the two front legs 12 of the front frame 10 below the front rods 814, and are connected removably to the front legs 12. The rear mounting members 825 are disposed on two opposite ends of the rear support 82 and are mounted removably and respectively on the rear legs 22 of the rear frame 20.

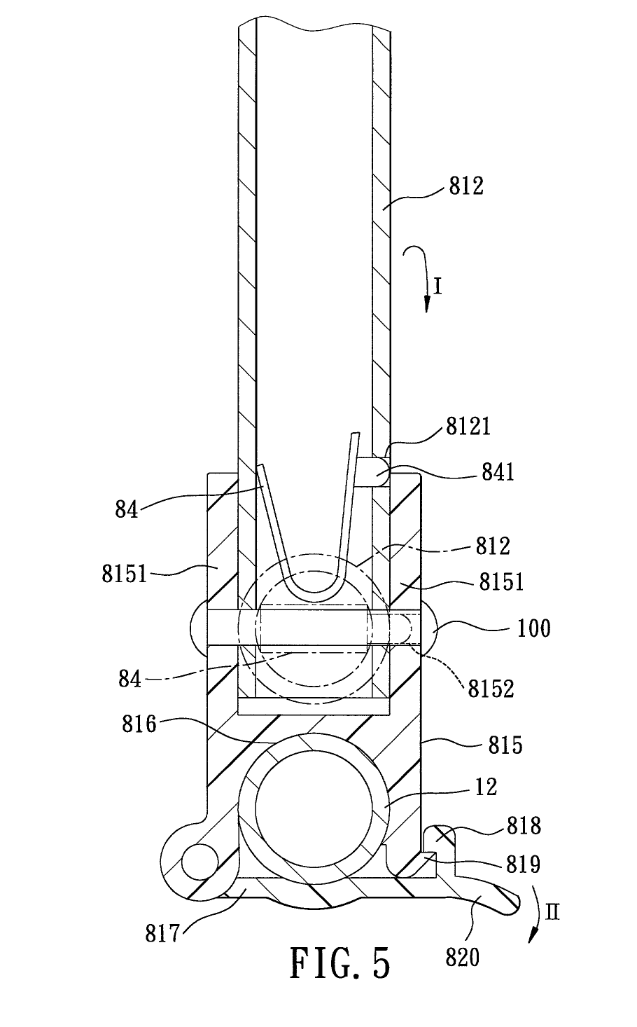

Each of the front mounting members 815 includes a U-shaped front embracing member 816 connected to the corresponding one of the front arms 812, and a front hinge plate 817 extending across the front embracing member 816. The front hinge plate 817 has one end pivoted to one end of the front embracing member 816, and an opposite end forming a locking portion 818 which interlocks with a projecting portion 819 (see FIG. 5) at the other end of the front embracing member 816. The front embracing member 816 and the front hinge plate 817 together clamp the corresponding one of the front legs 12 therebetween.

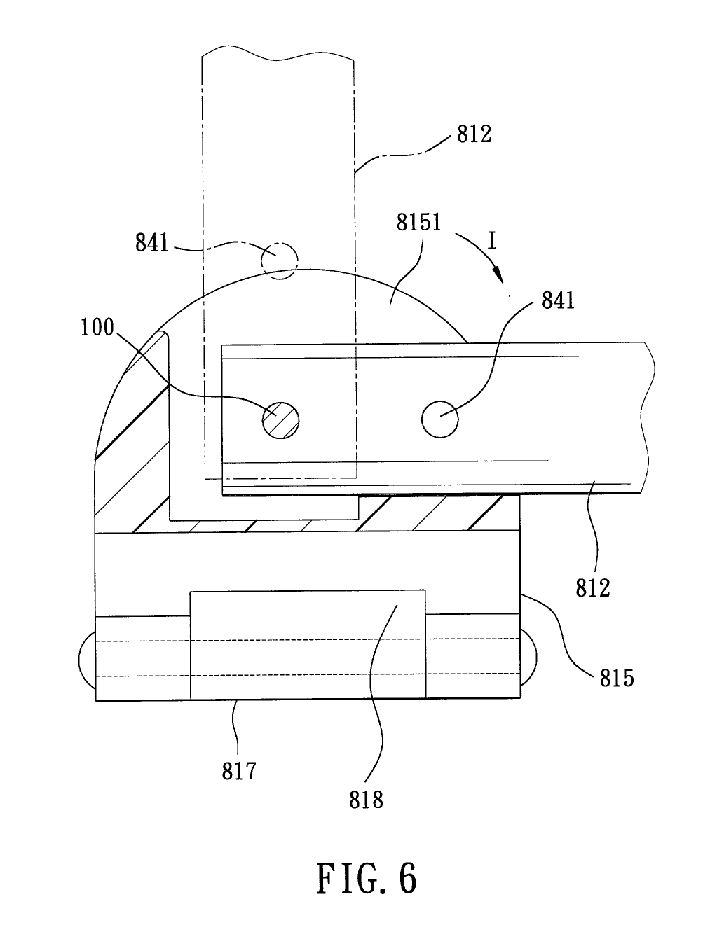

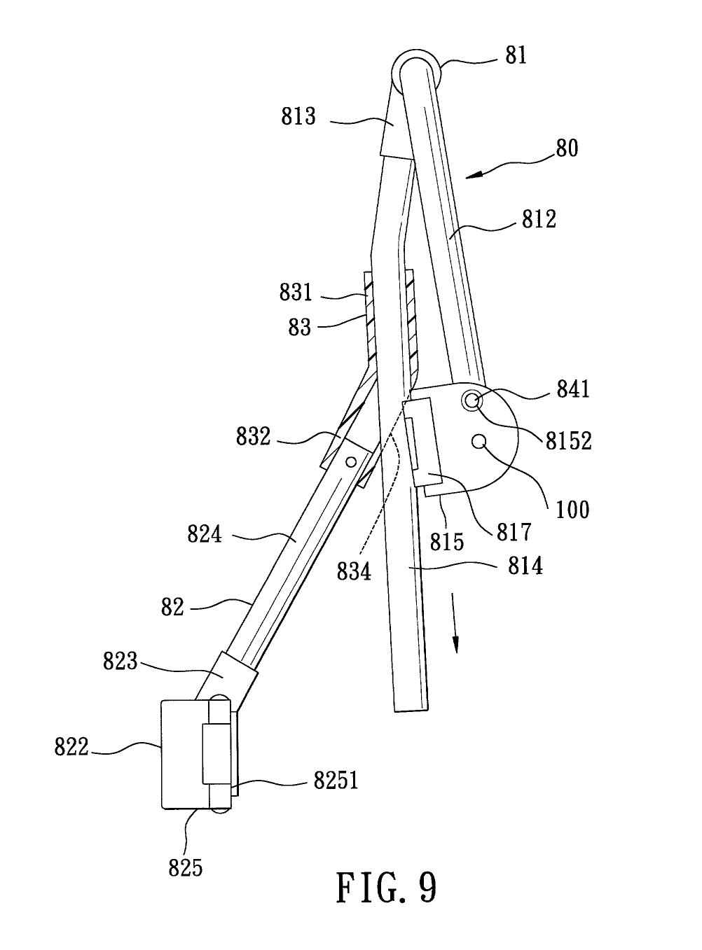

Each of the front mounting members 815 further includes a pair of wing plates 8151 projecting from the front embracing member 816 oppositely of the front hinge plate 817. The distal end of the corresponding one of the front arms 812 extends between and is pivoted to the wing plates 8151 via a pivot pin 100. One of the wing plates 8151 has a locking hole 8152 adjacent to the pivot pin 100. A spring plate 84 (see FIG. 5) is disposed inside the distal end of each front arm 812 and adjacent to the wing plates 8151, and has a projection 841 biased to project outward through a hole 8121 in the front arm 812. When the folding mechanism 70 is folded, the front arms 812 are folded in the direction indicated by the arrows “I” as shown in FIGS. 5 and 6 to a folded position as shown in FIG. 9, and the projection 841 engages the locking hole 8152 in the corresponding wing plate 8151.

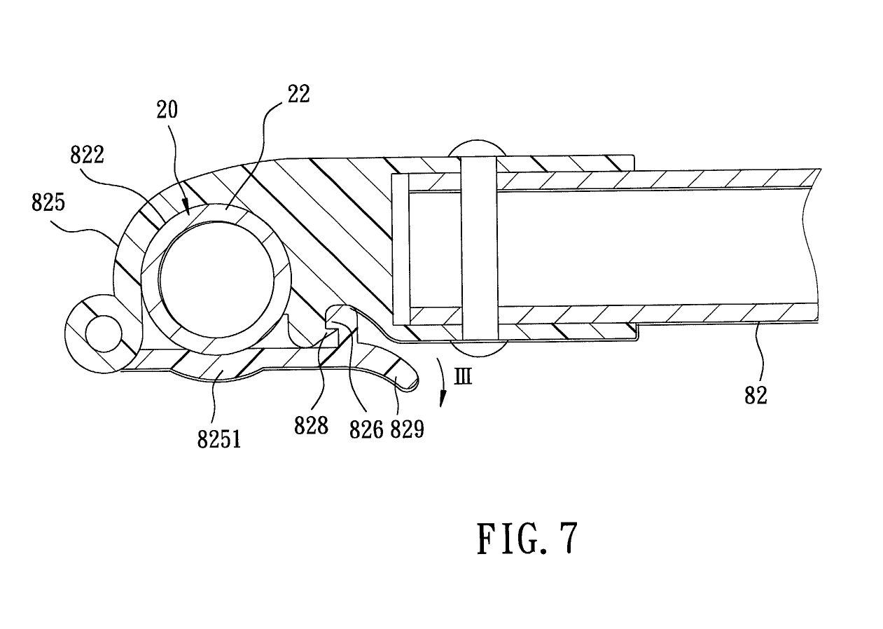

Referring to FIGS. 4 and 7, each of the rear mounting members 825 includes a U-shaped rear embracing member 822 fixed to the corresponding one of the opposite ends of the rear support 82, and a rear hinge plate 8251 extending across the rear embracing member 822. The rear hinge plate 8251 has one end pivoted to one end of the rear embracing member 822 and an opposite end provided with a locking portion 826 that interlocks with a projecting portion 828 at the other end of the rear embracing member 822. The rear embracing member 822 and the rear hinge plate 8251 together clamp the corresponding rear leg 22 therebetween.

The basket support frame 80 further includes a pair of front T-joints 813 respectively and pivotally connecting the front ends of the front rods 814 to the intermediate part 811 of the front support 81, and a pair of rear T-joints 823 respectively and pivotally connecting the rear ends of the rear rods 824 to the rear support 82.

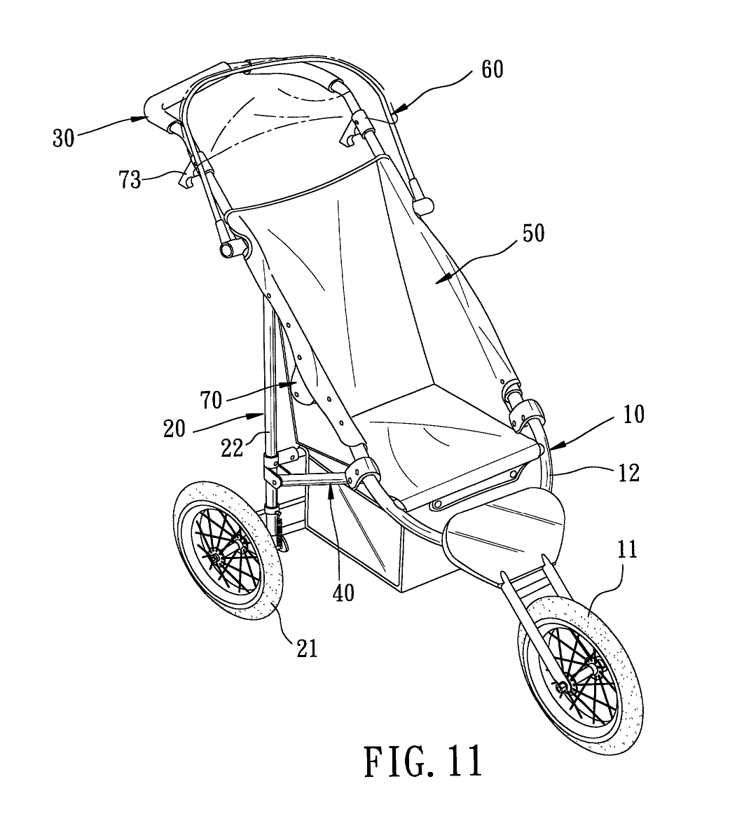

In use, the basket support frame 80 can be quickly assembled to the stroller by connecting the front and rear mounting members 815, 825 respectively to the front and rear frames 10, 20. The baby carrying basket 90 is placed and supported on the basket support frame 80, with fastening bands 91 at front and rear ends of the baby basket 90 tied around the front and rear supports 81, 82. Referring to FIG. 11, when the stroller is to be used for carrying a young child, the locking portions 818, 826 of the front and rear hinge plates 817, 8251 are respectively disengaged from the front and rear embracing members 816, 822 in the directions indicated by the arrows “II,” “III” with the aid of grip lugs 820, 829 (see FIGS. 5 and 7) to permit quick removal of the basket support frame 80 from the stroller.

During folding of the stroller with the basket support frame 80 mounted thereon, an actuating member 73 of the folding mechanism 70 is pulled in the direction indicated by the arrow “IV” shown in FIG. 3 such that the front and rear folding parts 71, 72 move toward each other to permit folding of the handle frame 30 along with the rear frame 20 in the direction indicated by the arrow “V.” By virtue of the arrangement of the links 40, the front frame 10 is brought toward the rear frame 20, as shown in FIG. 10. As a result, the front support 81 of the basket support frame 80 mounted on the front frame 10 is brought toward the rear support 82, as shown in FIG. 9, with the rear ends of the front rods 814 sliding downwardly relative to the passages 814 of the rear connecting parts 832.

From the aforesaid, it can be appreciated that the basket support frame 80 can be conveniently and quickly coupled to the stroller for carrying a baby basket 90.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A stroller capable of carrying a baby basket, comprising:
a wheeled front frame;
a wheeled rear frame;
a handle frame;
a pair of links pivotally interconnecting said front and rear frames;
a folding mechanism having front and rear folding parts interconnected pivotally for moving toward or away from each other to a folded position or an unfolded position, said front folding parts being connected to said front frame, said rear folding parts being connected to said rear and handle frames; and
a basket support frame including: a substantially U-shaped front support which has two opposite rearwardly extending front arms with distal ends, and an intermediate part between said front arms; a pair of connector tubes; a pair of front rods which have front ends connected pivotally to said intermediate part, and rear ends respectively and telescopically connected to said connector tubes; a pair of rear rods which have front ends respectively connected to said connector tubes and rear ends extending rearwardly; a rear support extending across and connected to said rear ends of said rear rods; a pair of front mounting members respectively connecting said distal ends of said front arms to said front frame below said front rods; and a pair of rear mounting members disposed on two opposite ends of said rear support and mounted on said rear frame.

2. The stroller as claimed in claim 1, wherein each of said connector tubes includes a front connecting part connected to the corresponding one of said front rods, and a rear connecting part connected to the corresponding one of said rear rods, said front connecting part being substantially horizontal in said unfolded position of said folding mechanism, said rear connecting part being inclined upward and rearward from said front connecting part and having a passage adjacent to said front connecting part, said rear end of the corresponding one of said front rods being received telescopically in said front connecting part and extending outward through said passage, said rear rods being respectively and fixedly connected to said rear connecting parts of said connector tubes.

3. The stroller as claimed in claim 1, wherein said basket support frame further includes a pair of front T-joints respectively and pivotally connecting said front ends of said front rods to said intermediate part of said front support, and a pair of rear T-joints respectively and pivotally connecting said rear ends of said rear rods to said rear support, said front mounting members being pivotally and respectively connected to said front arms of said front support.

4. The stroller as claimed in claim 2, wherein said rear mounting members are connected removably to said rear frame, said front mounting members being connected removably to said front frame.

5. The stroller as claimed in claim 4, wherein said rear frame includes two wheeled rear legs, each of said rear mounting members including a U-shaped rear embracing member fixed to the corresponding one of said opposite ends of said rear support, and a rear hinge plate extending across said rear embracing member, said rear hinge plate being pivoted to one end of said rear embracing member and interlocking with the other end of said rear embracing member, said rear embracing member and said rear hinge plate clamping therebetween a corresponding one of said rear legs.

6. The stroller as claimed in claim 5, wherein said front frame includes two front legs which extend forwardly and a front wheel attached to said front legs, each of said front mounting members including a U-shaped front embracing member connected to the corresponding one of said front arms, and a front hinge plate extending across said front embracing member, said front hinge plate being pivoted to one end of said front embracing member and interlocking with the other end of said front embracing member, said front embracing member and said front hinge plate clamping therebetween a corresponding one of said front legs.

7. The stroller as claimed in claim 6, wherein each of said front mounting members further includes a pair of wing plates projecting from said front embracing member oppositely of said front hinge plate, said distal end of the corresponding one of said front arms extending between and being pivoted to said wing plates.

8. The stroller as claimed in claim 7, wherein one of said wing plates has a locking hole, said distal end of each of said front arms having a spring-loaded projection biased to engage said locking hole when said folding mechanism is in said unfolded position.
